(19) United States
(12) Patent Application Publication
(10) Pub. No.: US 2001/0037416 A1
(43) Pub. Date: Nov. 1, 2001

(54) Communication system and method

(76) Inventor: Rob Theodorus Udink, Eindhoven (NL)

Correspondence Address: Corporate Patent Counsel, U.S. Philips Corporation, 580 White Plains Road, Tarrytown, NY, 10591, US

(21) Appl. No.: 09/790,341

(22) Filed: Feb. 21, 2001

(30) Foreign Application Priority Data
Feb. 25, 2000 (EP) 00200667.4

(51) Int. Cl. G06F 9/00

(52) U.S. Cl. 709/331

(57) ABSTRACT

A communication system (100) including a controller station (114) and a controlled station (102), interconnected via a communication network (120). A set of functions of the controlled station (102) is accessible through a base software element. An extension to said set of functions is accessible through an extended software element, which has a link to the base software element. Also a method of providing standardized extended functionality in the communication system (100).

The invention relates to a communication system including a controller station and a controlled station, interconnected via a communication network, a set of functions of the controlled station being accessible through a base software element.

The invention further relates to a method of providing standardized extended functionality in a communication system including a controller station and a controlled station, interconnected via a communication network, a set of functions of the controlled station being accessible through a base software element.

Multimedia consumer electronics systems may comprise in-home digital networks, using DVB and similar technologies to provide multimedia content to consumers. To allow the many different devices that can be used in such a system to interact, several standards have been defined. One such standard is the Specification of the Home Audio/Video Interoperability (HAVi) Architecture, Version 1.0, January 2000 Digital Video Broadcasting (DVB); Guidelines on implementation and usage of Service Information (SI), ETR 211, August 1997, second edition. The invention will be discussed in part in terms of the HAVi architecture below, although it is to be understood that the invention can also be applied to similar architectures and systems without deviating from the scope of the application.

A multimedia system according to the invention may comprise of a plurality of stations. A station may act as a controller station, controlling one or more of the other stations, acting as controlled station(s). A station makes its local functionality available in the form of a set of functions, which can be accessed by transferring messages. The set of functionality can be seen as an abstract representation of the actual underlying functionality, which is provided by the hardware, and/or software of the station. The representation is abstract in the sense that no strict one-to-one relationship between the externally offered functions and the internal implementation is required. Typically, the representation is standardized whereas the actual implementation is vendor or even model specific. Consequently, the station maps the abstract representation (AR) into internal control mechanisms and controls the underlying hardware/software accordingly (e.g. using an internal bus, such as I2C, to control hardware components). Such a mapping and control is usually performed in software. This also covers the functionality required to map the abstract representation to the concrete representation of the underlying hardware/software of the station.

The AR can be controlled using a messaging mechanism. Command messages are defined for each function instructing a station to perform a defined task. Request messages allow information to be retrieved from the station with respect to the execution of a function, such as the state of the station. Event messages enable the station to inform another station of events, such as state changes, which have occurred in the station.

In a controlling station, the task of controlling functionality of another station is assigned to the so-called Audio/Video Controller (AV/C). The AV/C acts independently of any of the other controlling stations. Typically, the AV/C starts a control sequence, usually referred to as feature or application, in reaction to a trigger from a user (e.g. a user has pressed a button on a remote control) or an event which has occurred in the system. A typical example of an application executed by the AV/C is the automatic play feature. For this feature, in response to the user activating the playback function of a VCR (e.g. pressing a play button or inserting a tape), the AV/C instructs the VCR deck to play the tape, instructs the VCR to make the A/V signal originating from the tape available to the TV, and instructs the TV to provide the signal from the VCR to the monitor. It will be appreciated that for this example the controlling AV/C is preferably, although not strictly required, located in either the TV or VCR to reduce the number of command messages. Several AV/Cs may be present in the stations. A station may over time or even simultaneously act as a controlling station or as a controlled station.

An FCM is a (software) abstraction providing access to functionality of a controlled station through the FCM. It contains code for executing functions related to the controlled station, such as the ones mentioned above. An FCM has a vendor ID, which identifies the vendor or manufacturer of the FCM. This allows a vendor to add his own vendor-specific extensions to standard defined FCM's. However, because the indicated vendor ID indicates a vendor, this method can not be used to extend the standard by another entity, such as a standardization body.

It is an object of the invention to provide a communication system of the kind set forth which is flexible with respect to extending the functionality.

This object is achieved according to the invention in a communication system characterized by an extension to said set of functions being accessible through an extended software element, the extended software element comprising a link to the base software element for enabling access to the base software element. In such a system, the extended functionality can be accessed through the extended software element, and the set of functions offered through the base software element still exists and can be used normally. If a station uses the extended functionality, it can still also access the set of functions by following the link to access the base software element. A station which has no knowledge of the mechanism for extended functionality can still operate without problems, making the communication system backwards compatible. Preferably, the communication system is of the Home Audio/Video interoperability (HAVi) architecture. In that case, the base software element is best realized as a HAVi Tuner FCM.

In an embodiment the link comprises a software element identifier (SEID) for the base software element. The SEID is guaranteed to be unique in the communication system, so it is a very suitable candidate for locating the base software element, for instance by searching a registry using the SEID as a key for the station holding the base software element.

In a further embodiment the extended software element comprises computer code for executing a function call which returns said software element identifier. By implementing a standard function call or, when object-oriented software is used, a method, to read out the SEID, it is very easy for other stations to find out which base software element is being linked to.

In a further embodiment the extended software element has been registered in a registry for enabling querying the registry to locate the extended software element. The registry can be used to locate software elements having specific functionality, so registering the extended software element is then necessary to make the extended functionality available.

In a further embodiment the base software element comprises a first vendor identifier and the extended software element comprises a second vendor identifier, the second vendor identifier being different from the first vendor identifier. The second vendor identifier preferably identifies one of a standardization body and a consortium, such as the Digital Video Broadcasting (DVB) consortium. The vendor ID, in combination with an error message number, method identifier or software element type, can be used to create unique vendor-specific error messages, method identifiers or software elements. This allows manufacturers to extend standard FCMs with their own specific extensions. However, because the indicated vendor ID indicates a vendor, this method can not be used to extend the standard by another entity, such as a standardization body or consortium. They can now provide an extended software element with their own vendor identifier, and link it to a base software element having the identifier of its vendor or manufacturer.

It is a further object of the invention to provide a method according to the preamble, which is flexible with respect to providing said functionality.

This object is achieved according to the invention in a method which is characterized by registering in a registry an extended software element which provides access to the standardized extended functionality, said extended software element comprising a link to the base software element for enabling access to the base software element. By registering the extended software element in the registry, other applications can locate it, or locate functionality provided by it. The functionality offered by the base software element can also still registered.

In an embodiment the method further comprises querying the registry to locate the extended software element, which extended software element comprises computer code for executing a function call which returns a software element identifier for the base software element; executing said function call to obtain said software element identifier; querying the registry to locate the base software element; and accessing the set of functions being accessible through said base software element.

These and other aspects of the invention will be apparent from and elucidated with reference to the embodiments shown in the drawings, in which:

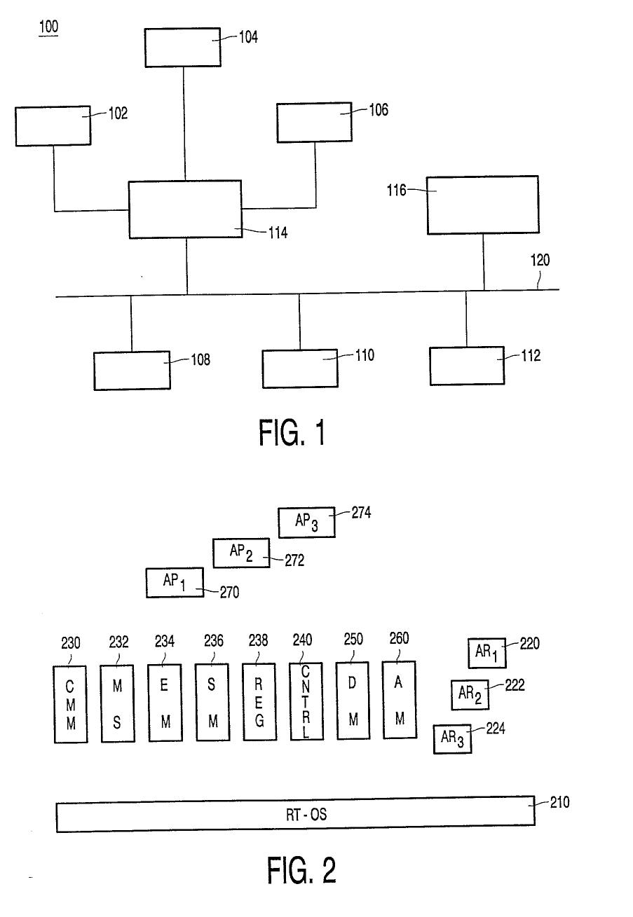

FIG. 1 is a block diagram of a system with consumer devices according to the invention; and

FIG. 2 is a block diagram of the software architecture of a controller station in the system of FIG. 1.

Throughout the figures, same reference numerals indicate similar or corresponding features. Some of the features indicated in the drawings are typically implemented in software, and as such represent software entities, such as software modules or objects.

FIG. 1 is a block diagram of a control system 100 according to the invention. System 100 comprises at least one controlled station; shown are the controlled stations 102, 104, 106, 108, 110, . . . , and 112. System 100 further includes a plurality of controller stations. The figure illustrates the controller stations 114 and 116. The controller stations are connected via the main communication network 120 of the system, for instance based on IEEE 1394, using the same higher-level communication protocols. Controlled stations 102-106 are directly connected to controller station 114. The connection may be via any suitable communication means, such as a proprietary network. Controlled station 108 is connected to the main network 120, but does not use all protocols required to make its AR available for control in a way required for the main network 120. However, station 108 may use other protocols (e.g. proprietary or according to a different standard) and as such be able to communicate to a controller station.

In the system, a distinction is made between controller stations (or, shortly, controllers) and controlled stations. A controller is a station that acts as a host for a controlled station. A controlled station and its controller may reside on the same physical device or on separate devices. A controller is said to host an abstract representation (AR) for the controlled device. The control interface is exposed via the API (Application Program Interface) of this AR. This API is the access point for applications (features) to control the station. For instance, an intelligent television in the family room might be the controller for a number of interconnected controlled stations. A controlled station could contain code that constructs a user interface for the station and allows external control of the station. When such a station is first connected, the controller obtains the user interface and control code. An icon representing the station may then appear on the television screen, and manipulating the icon may cause elements of the control program to actuate the represented station or stations in prescribed ways.

In order to appreciate the operation and versatile character of system 100, a categorization of the communications abilities of consumer electronics stations 102-112 is discussed first. While in reality there is a smoother continuum of device capabilities than is acknowledged here, this categorization is useful in understanding the model of system 100. The communication capabilities of the stations 102-112 in this generic example have different levels of sophistication. Dependent on their communication capabilities, stations 102-112 belong to one of the following classes:

Controller stations

A distinction can be made between the following two types of controller stations:

Full AV Device (FAV)

A Full AV device generally has a rich set of resources and is capable of supporting a complex software environment. The primary distinguishing feature of a FAV is the presence of a runtime environment for executing an abstract representation (AR) for a controlled station. This allows a FAV to upload an AR from other stations or via other local area or wide area communication networks and so provide enhanced capabilities for their control. The FAV may also be able to download applications/features. Preferably, the downloaded code is some form of executable code of a virtual machine (e.g. Java or similar bytecodes). Likely candidates for FAV devices would be Set Top Boxes (STB), Digital TV receivers (DTV), general purpose home control devices, and even Home PC's.

Intermediate AV Device (IAV)

Intermediate AV devices are generally lower in cost than FAV devices and more limited in resources. They do not provide a runtime environment for downloadable ARs and so can not act as controllers for arbitrary devices within the system. However, an IAV may provide native support for control of particular controlled station(s) in the system.

Controlled stations

A distinction can be made between the following two types of controller stations:

Base AV Device (BAV)

These are devices that, for business or resource reasons, choose to implement future-proof behavior by providing an uploadable AR, but the devices themselves do not execute an AR. These devices can be controlled by a controller station (by a FAV device via the uploadable bytecode or by an IAV device via native code). The protocol between the BAV and its controller station typically is proprietary. Communication between a controller station and a BAV device requires that commands for the AR are translated to and from the command protocol used by the BAV device. This translation is performed by the controller station executing the AR.

Legacy AV Device (LAV)

LAV devices are devices that do not comply with the described system architecture and communication protocols. Typically, such devices were built earlier. These devices use proprietary protocols for their control, and usually have simple control-only protocols. Such devices can work in the home network but require that FAV or IAV devices act as a gateway. Communication between a Full or Intermediate AV device and legacy AV device requires that commands be translated to and from the legacy command protocol.

During the course of interaction, stations may exchange control and data in a peer-to-peer fashion. This ensures that, at the communication level, no one device is required to act as a master or controller for the system. However, it also allows a logical master or controller to impose a control structure on the basic peer-to-peer communication model.

Software Architecture

The software architecture of a controller station is shown in FIG. 2. The software elements of the architecture support the basic notions of network management, device abstraction, inter-device communication, and device User Interface (UI) management. Collectively these software elements expose the Interoperability API, a set of services for building portable distributed applications in the system. The software elements themselves reside above a vendor specific platform 210, such as a Real-time Operating System. FIG. 2 depicts the arrangement of software elements on a controller station. While not intended as an implementation blueprint, the diagram does highlight how the software elements form a middle layer between platform specific APIs and platform independent applications. An important software element is the Abstract Representation (AR). Indicated are three ARs (220, 222, and 224). The AR is a software element used to control a station. An AR comprises code for the AR itself plus code for Functional Component Modules (FCMs) for each functional component within the controlled station. An FCM is a (software) abstraction of a functional component providing the functionality of that functional component to the software environment and applications. Applications do not communicate with a functional component directly but only through the FCM, the FCM on its turn does not communicate with the functional component directly but always via the AR (this is at least the model used to present the relation). An FCM is an object in the sense that it may be registered as a receiver in a registry (details are provided below) and it can communicate with other objects via a messaging system. A functional component represents functions associated with one identifiable main function of a station. E.g. a VCR AR may comprise separate FCMs for the tape deck and the tuner; a TV AR may comprises separate FCMs for the monitor, PIP (picture in picture display) and tuner. In addition an AR may include a device control application—a software element allowing user control of the device and its functional components. In the Figure, AR 220 represents the functionality of the controller station itself, whereas AR 222 and 224, respectively, represents functionality of two controlled stations.

The controller station comprises control means 240, which provides a runtime environment for ARs (e.g. uploaded ARs) or applications. The controller station further comprises AR distribution means 250 and AR allocation means 260. The AR allocation means 260 allocate an AR, which has been assigned to be executed on this controller station, to the control means 240 for execution. The distribution means 250 performs the task of the AR Manager, which controls installing and removing ARs on controller stations.

ARs are a central concept to the architecture and the source of flexibility in accommodating new devices and features. ARs come in two main types:

embedded AR—an AR pre-installed on a controller station.

uploaded AR—an AR implemented using downloadable code, e.g. bytecode. Uploaded ARs only run on FAV devices.

Preferably, an embedded AR is capable of being used to control a range of controllable stations, such as a range of VCRs of one manufacturer. If so, preferably, the controller station obtains additional information of the actual controlled station involved (e.g. by reading a model number via a network) and adjusts the generic AR to operate optimally for the specific controlled station. As such, ARs can provide APIs for control of families of devices or, optionally, of specific models only. Generally the family-oriented ARs will have a wider range of usage, but the specific ARs allow control of vendor-specific features and capabilities.

For a controlled station an associated AR must be present in the system and running for the controlled station being able to participate. For a BAV device, the AR may be obtained (downloaded) directly from storage in the BAV device or from other storage associated with the BAV device (such as a harddisk located in another station on the network or even via access through a wide area network). In the latter case an indication of the storage location is stored for the controlled station. This indication may be stored in the controlled station itself or in another station, such as a controller station or a central station. For LAV devices, the AR is pre-installed on the controller station or obtained from any storage location. Similarly, also for a controller station in order to be used by applications/features in other stations a running AR is required. Normally, such AR will be running in the controller station itself, although this is not strictly required.

A controller station may also comprise one or more applications (features); shown are applications 270, 272 and 274. The application sends messages to one or more involved ARs. The ARs may be located in the same station, or in another station in which case the message is transferred via the network.

Other software elements may be included in the controller station as well, such as:

A Communication Media Manager 230—allows other elements to perform communication, such as asynchronous and isochronous communication over the network. Preferably IEEE 1394 is used as the network.

Messaging System 232—responsible for passing messages between elements.

Event Manager 234—serves as an event delivery service. An event is the change in state of an object or of the home network.

Stream Manager 236—responsible for managing real-time transfer of AV and other media between functional components.

Registry 238—serves as a directory service, allows any object to locate another object on the home network.

Stations in the system may contain descriptive data (Self Describing Device data or SDD) about the station and its capabilities. If IEEE 1394 is used as the network, preferably this information follows the IEEE 1212 addressing scheme used for Configuration ROM. The SDD data may include AR code and data for constructing user interface elements.

Communication Media Manager

The Communication Media Manager (CMM, 230) is a medium dependent entity in the network. It interfaces with the underlying communication medium to provide services to other components or application programs residing in the same device as the CMM resides. Each physical communication medium has its own CMM to serve the above purposes. Here the CMM for the IEEE 1394 bus is described in more detail.

Two types of services are provided by the CMM. One is to provide a transport mechanism to send requests to and receive indications from the remote devices. The other is to abstract the bus activities and present the information to the system. The IEEE 1394 bus is a dynamically configurable network. After each bus reset, a device may have a completely different physical ID than it had before. If a network component or an application has been communicating with a device in the network, it may still want to continue the communication after a bus reset, though the device may have a different physical ID. To identify a device uniquely regardless of frequent bus resets, Global Unique ID (GUID) is used by the CMM and other entities. GUID is a 64-bit number that is composed of 24 bits of node-vendor ID and 40 bits of chip ID. While a device's physical ID may change constantly, its GUID is permanent. The CMM makes device GUID information available for its clients.

One of the advanced features of the 1394 bus is its support for dynamic device actions such as hot plugging and unplugging. To fully support this up to the user level, system components or applications need to be aware of these environment changes. The CMM works with Event Manager (EM) to detect and announce such dynamic bus changes. Since any topology change within 1394 bus will cause a bus reset to occur, the CMM can find out the changes and post the event to the Event Manager about these changes along with the associated information. The Event Manager will then distribute related events to all interested entities or applications.

Messaging System

The messaging system 232 provides the software elements with communication facilities. It is independent of the network and transport layers. A messaging system is embedded in any FAV and IAV device. The messaging system of a device is in charge of allocating identifiers for the software elements of that device. These identifiers are firstly used by the software elements for registration. They are then used by the software elements to identify each other within the home network: when a software element (A) wants to send messages to another software element (B) it has to use the software element identifier of B while invoking the messaging system API.

Device Control

In the system according to the invention, an AR should exist for each BAV and LAV device known in that network. The AR provides an interface to the device and presents it as a software element in the architecture. Within an AR several FCMs are contained representing the functional components of the device and which are also presented as software elements in the architecture. Other applications can query the registry to find out the devices and functional components available and to get a software element identifier to allow them to interact with the device via the AR and the FCMs. ARs are handled by a FAV or IAV that can install them. Installation of an AR code unit results in the installation of all the associated FCMs. The code can be written in a standard bytecode, in which case they can be installed on all FAV devices, or in some native code, in which case they can be installed only on (and by) some FAV or IAV that knows that code and is prepared for that kind of code.

Functional Component Module (FCM).

An FCM is a (software) abstraction of a functional component providing the functionality of that functional component to the software environment and applications. Applications will not communicate with a functional component directly but only through the FCM, the FCM on its turn does not communicate with the functional component directly but always via the AR (this is at least the model used to present the relationship; the FCM implementation may communicate with the CMM directly). An FCM is a software object in the sense that it is registered as a receiver in the registry and it can communicate with other objects via the messaging system. Via the messaging system it offers the command protocol according to the conventions of the system.

In the registry, each software element (such as an FCM or a DCM) is defined by a set of constants. In the context of the HAVi architecture, the most important of these constants are the software element type, the vendor ID and the HUID. The software element type identifies the type of the element (e.g. Tuner, Registry, etc.). The HUID is the HAVi unique ID of the device hosting the element. The vendor ID identifies the vendor or manufacturer of the FCM. This value is standardized by IEEE.

The vendor ID can be used to extend the specification. The vendor ID, in combination with an error message number, method identifier or software element type, can be used to create unique vendor-specific error messages, method identifiers or software elements. This allows manufacturers to extend standard FCMs with their own specific extensions. However, because the indicated vendor ID indicates a vendor, this method can not be used to extend the standard by another entity, such as a standardization body.

If another entity wants to extend the standard, the extension needs to be identified as an extension by for example DVB. An application requiring such additional functionality must be able to locate the functionality easily and unambiguously. This requires that the extended functionality can be located using the registry. However, the original interface should also still be present and manufacturers should be able to extend it in the manner described above. If the extension were to replace a vendor-provided FCM, this would make it impossible for that vendor to provide his own extensions. Few vendors would be willing to take this step.

To solve this issue, so-called views or interfaces on the basic software element are introduced. The registry 238 now may contain not only the existing, software element, but also one or more views on this software element. These views hold the standardized extension methods and a link to the base software element. The mechanism to create such views is that the FCM registers as a set of software elements in the registry 238.

The base software element holds the vendor ID of the manufacturer of the software element. The extended software element is a view or interface on the base software element. Although it is registered under a separate SEID, it is directly linked to the base software element.

In such a system, the base software element represents the access point to the standard functionality of the software element. All the standard functionality can be accessed using the base software element, e.g. if the base software element represents a FCM, all resource management of this FCM should be done using the base software element and not the extended software element. The extended functionality, in contrast, can only be accessed through the function calls available in the extended software element. These may function as a ‘wrapper’ around the functionality of the base software element, for example by providing a standardized parameter format.

The extended software element realized in this fashion does not have to copy all the functionality of the base software element. The link provides access to the base software element, and thereby to the functionality provided therein. Only the extended functionality needs to be implemented in the extended software element.

Because the vendor ID of this extension is the vendor ID the entity creating the extension, all software elements, methods, attributes, and error identifiers can be uniquely defined by the entity in question using the range for proprietary extensions.

To provide a direct link to the base software element 310, the extended software element provides the SEID of the base software element 310. This allows an application to search the registry 238 for the required, standardized combination of SEID and vendor ID. When this combination is found, the base software element is also found. This requires however that the extended software element and the base software element be linked. When the extension is present, the base should also be present.

The base software element can be recognized using the standard-defined software element type. The extended software element can be identified using a private software element type and the vendor ID.

In the below embodiment of the invention, a DVB-related extension is made to a HAVi Tuner FCM. This extended FCM can provide a link to further extensions. Because the extension is a focal point of any DVB extensions, a DVB residential gateway should always provide a DVB-Tuner extension for each Tuner FCM. Furthermore, some basic utility methods and a method allowing the selecting of the transport stream source of a tuner without selecting any components to be streamed over the IHDN are provided. This functionality is required by the MHP tuner API. An example utilization of this functionality is selecting a transport stream to filter some MPEG-2 sections.

In order to make the extended FCM available, it must be registered in the Registry 238. The vendor ID and SEID attributes are required, and are defined in as follows:

| | | Size | |
|---|---|---|---|
| Registry Attribute Name | IDL Type | (bytes) | Value |
| ATT_VENDOR_ID | VendorId | 3 | DVB vendor |
| | | | id |
| ATT_SEID | SoftwareElementType | 4 | 0x8000 0000 |

The extended FCM offers the following services:

| | Comm | | Ac- | Resv |
|---|---|---|---|---|
| Service | Type | Locality | cess | Prot |
| DvbTunerExt::GetDvbSiSeid | M | global | all | |
| DvbTunerExt::GetSfSeid | M | global | all | |
| DvbTunerExt::GetBaseFcmSeid | M | global | all | |
| DvbTunerExt::SelectSourceTs | M | global | all | Yes |
| DvbTunerExt::GetBouquetServiceLists | M | global | all | |
| DvbTunerExt::GetNetworkServiceLists | M | global | all | |

Using this extended FCM, other extended FCMs can be added. In particular, basic functionality is provided for adding a service information extension and a section filtering extension. The services are all explained below.

DvbTunerExt::GetBaseFcmSeid

Prototype

Status DvbTunerExt::GetBaseFcmSeid(

out SEID baseFcmSeid)

Parameters

baseFcmSeid—the SEID of the Tuner FCM this is an extension on.

Description

This method returns the software element identifier of the HAVi Tuner FCM extended by the services of the invention.

DvbTunerExt::GetDvbSiSeid

Prototype

Status DvbTunerExt::GetDvbSiSeid(

out SEID dvbSiSeid)

Parameters

dvbSiSeid—the SEID of the SI extension of this Tuner FCM.

Description

This method returns the software element identifier of the service information extension of the DVB Tuner.

Error codes

ENOTIMPLEMENTED—the tuner does not implement a DVB-SI extension.

DvbTunerExt::GetSfSeid

Prototype

Status DvbTunerExt::GetSfSeid(

out SEID sfseid)

Parameters

sfSeid—the SEID of the section filtering extension of this Tuner FCM.

Description

This method returns the software element identifier of a section filter extension of the DVB Tuner.

Error codes

ENOTIMPLEMENTED—the tuner does not implement a DVB-SI extension.

DvbTunerExt::SelectSourceTs

Prototype

Status DvbTunerExt::SelectSourceTs(

in ServiceLocator ts)

Parameters

ts—the ServiceLocator representing the transport stream that the tuner, connected to the HAVi Tuner FCM, is tuned to.

Description

This method changes the MPEG2-TS selection of the HAVi Tuner FCM for this DVB Tuner FCM Extension. Selecting an MPEG2-TS will not generate any streaming on the output plugs. Only the MPEG2-TS source is selected as a preparation for SI filtering and/or section filtering. The method allows the Section Filter and DVB-SI Extension to access different transport streams without streaming information over the HLN.

Selecting a transport stream will stop the streaming of any MPEG2-TS components of an MPEG2-TS.

This method is mandatory for all DVB Tuner FCMs that also implement the Section Filter or DVB-SI Extension.

Error codes

ENOTIMPLEMENTED—the SelectSourceTs method is not supported by the DVB Tuner FCM.

DvbTunerExt::ELOCATOR—if the Tuner FCM cannot resolve the locator.

DvbTunerExt::GetBouquetServiceLists

Prototype

Status DvbTunerExt::GetBouquetServiceLists(

out ushort startListNumber,

out ushort endListNumber)

Parameters

startListNumber—the list number of the first bouquet service list.

endListNumber—the list number of the last bouquet service list.

Description

This method returns the start and end list number of the service lists representing bouquets known to the tuner FCM (Tuner::GetServiceList and Tuner::GetServiceListInfo).

Error codes

ENOTIMPLEMENTED—the base Tuner FCM does not support bouquet lists

TUNER::ELIST—no bouquets are known to the tuner.

DvbTunerExt::GetNetworkServiceLists

Prototype

Status DvbTunerExt::GetNetworkServiceLists(

out ushort startListNumber,

out ushort endListNumber)

Parameters

startListNumber—the list number of the first network service list.

endListNumber—the list number of the last network service list.

Description

This method returns the start and end list number of the of the service lists representing networks known to the tuner FCM (Tuner::GetServiceList and Tuner::GetServiceListlnfo).

Error codes

ENOTIMPLEMENTED—the base Tuner FCM does not support network lists

TUNER::ELIST—no networks are known to the tuner.

1. A communication system (100) including a controller station (114) and a controlled station (102), interconnected via a communication network (120), a set of functions of the controlled station (102) being accessible through a base software element, characterized by an extension to said set of functions being accessible through an extended software element, the extended software element comprising a link to the base software element for enabling access to the base software element.

2. The communication system (100) of claim 1, whereby said communication system (100) is of the Home Audio/Video interoperability (HAVi) architecture.

3. The communication system (100) of claim 2, wherein said base software element is a HAVi Tuner FCM.

4. The communication system (100) of claim 1, wherein the link comprises a software element identifier (SEID) for the base software element.

5. The communication system (100) of claim 4, wherein the extended software element comprises computer code for executing a function call which returns said software element identifier.

6. The communication system (100) of claim 1, wherein the extended software element has been registered in a registry (238) for enabling querying the registry (238) to locate the extended software element.

7. The communication system (100) of claim 1, wherein the base software element comprises a first vendor identifier and the extended software element comprises a second vendor identifier, the second vendor identifier being different from the first vendor identifier.

8. The communication system (100) of claim 7, wherein the second vendor identifier identifies one of a standardization body and a consortium.

9. The communication system (100) of claim 7, wherein the second vendor identifier identifies the Digital Video Broadcasting (DVB) consortium.

10. A method of providing standardized extended functionality in a communication system (100) including a controller station (114) and a controlled station (102), interconnected via a communication network (120), a set of functions of the controlled station (102) being accessible through a base software element, the method being characterized by registering in a registry (238) an extended software element which provides access to the standardized extended functionality, said extended software element comprising a link to the base software element for enabling access to the base software element.

11. The method of claim 10, further comprising querying the registry (238) to locate the extended software element, which extended software element comprises computer code for executing a function call which returns a software element identifier for the base software element; executing said function call to obtain said software element identifier; querying the registry (238) to locate the base software element; and accessing the set of functions being accessible through said base software element.
